(19) United States
(12) Patent Application Publication
(10) Pub. No.: US 2004/0160917 A1
(43) Pub. Date: Aug. 19, 2004

(54) Multibeam antenna for a wireless network

(76) Inventors: Ihab H. Eliznd, San Jose, CA (US); Emmanuel Philosoph, Santa Clara, CA (US)

Correspondence Address: LAW OFFICE OF DEREK J. WESTBERG, 2 NORTH SECOND STREET, SUITE 1390, SAN JOSE, CA, 95113, US

(21) Appl. No.: 10/680,844

(22) Filed: Oct. 6, 2003

Related U.S. Application Data
(63) Continuation-in-part of application No. 09/988,116, filed on Nov. 16, 2001.
(63) Continuation-in-part of application No. 09/590,780, filed on Jun. 8, 2000.
(60) Provisional application No. 60/249,690, filed on Nov. 17, 2000.
(60) Provisional application No. 60/140,717, filed on Jun. 22, 1999.
(60) Provisional application No. 60/416,996, filed on Oct. 7, 2002.

(51) Int. Cl. H04Q 7/00

(52) U.S. Cl. 370/334; 370/389

(57) ABSTRACT

An apparatus, system and method for transmitting packets over a wireless network, wherein the packet identifies an antenna and/or antenna element among a plurality of antenna and/or antenna elements for transmitting the packet. The plurality of antenna elements is a multibeam antenna with a substantially conical or cylindrical construction.

This is a continuation-in-part application of U.S. patent application Ser. No. 09/988,116, filed Nov. 16, 2001, which claims the benefit of U.S. Provisional Application No. 60/249,690 filed Nov. 17, 2000. This is a continuation-in-part application of U.S. patent application Ser. No. 09/590,780 filed Jun. 8, 2000, which claims the benefit of PCT application Ser. No. PCT/US99/17793 filed on Aug. 6, 1999, which claims the benefit of U.S. Provisional Application No. 60/095,720 filed on Aug. 7, 1988 and U.S. Provisional Application No. 60/140,717 filed on Jun. 22, 1999. This application claims the benefit of U.S. Provisional Application No. 60/416,996 filed Oct. 7, 2002. application Ser. No. 09/590,780, application Ser. No. 09/988,116, application Ser. No. 60/095,720, application Ser. No. 60/140,717, application Ser. No. 60/249,690, application Ser. No. 60/416,996 and PCT application Ser. No. PCT/US99/17793 are each hereby incorporated by reference in its entirety.

### FIELD OF THE INVENTION

The present invention generally relates to antennas, and more particularly, to the use of multibeam antennas and/or multiple antennas with a packet-based protocol.

### BACKGROUND OF THE INVENTION

A conventional antenna is a point source and is designed to transmit an omni-directional communication beam that radiates in all directions at once like a light bulb. In contrast a directional antenna transmits a directional communication beam that radiates in only one direction, like a flashlight or a laser. One characteristic of the directional communication beam is its divergence. The divergence is a measure of the rate of expansion of the beam. The smaller the divergence the farther the beam with a given energy will travel. Whereas, the omni-directional communication beam is a sphere, the directional communication beam is similar to a cone with the antenna at its point. The cone may have a circular or elliptical base. The divergence of the directional communication beam may be so small that the directional communication beam is almost cylindrical in shape. Thus, a directional antenna can have a longer range than a conventional antenna, with the same power, but over a narrower region of space.

FIG. 1A is a side view of an exemplary planar multibeam antenna 100 as practiced in the prior art. The antenna 100 is comprised of two or more directional antenna elements 102. FIG. 1B is a top view of the antenna 100, showing communication beams 104 as produced by antenna 100. Each element 102 produces one communication beam 104 (e.g., element #1 produces communication beam #1). A series of elements one through n are positioned in a row to produce a row of communication beams one through n that cover a wide area. What is needed is an improved multibeam antenna and a method of use. It is to these ends that the present invention is directed.

### BRIEF SUMMARY OF THE INVENTION

The present invention is a multibeam antenna for a wireless network and a system and method for a Customer Premises Equipment (CPE) and a Base Transmitter Station (BTS) to communicate using multiple antennas and/or multibeam antennas. The CPEs and/or BTS may communicate with each over a conventional wireless network using a packet protocol. A packet using the packet protocol may include one or more fields that identify to the CPE and/or BTS, and which antenna and/or antenna element to use. The multibeam antenna may include a plurality of directional antenna elements, wherein each element is oriented in a different direction relative to an axis, thereby forming a cylindrical or conical multibeam antenna.

### BRIEF DESCRIPTION OF THE DRAWINGS

FIG. 1A is a side view of the planar multibeam antenna as practiced in the prior art;

FIG. 1B is a top view of the planar multibearn antenna as practiced in the prior art and the communication beams produced by the planar multibeam antenna;

FIG. 2 is an illustration of a wireless cell, in which an embodiment of the invention may be practiced;

FIG. 3 shows a data packet, in accordance with an embodiment of the invention;

FIG. 4C shows a multiport transceiver for a multibeam antenna connected to a BTS or a CPE in accordance with an embodiment of the present invention;

FIG. 4D shows a plurality of transceivers for a multibeam antenna connected to a BTS or a CPE in accordance with an embodiment of the present invention;

FIG. 5 illustrates a first exemplary system in which an embodiment of the invention may be implemented;

FIG. 6 illustrates a second exemplary system in which an embodiment of the invention may be implemented;

FIG. 7 is a block diagram of an exemplary BTS, which may be used in accordance with an embodiment of the present invention;

FIG. 8 is a block diagram of an exemplary CPE, which may be used in accordance with an embodiment of the present invention;

FIG. 9A is a side view of a cylindrical multibeam antenna in accordance with an embodiment of the present invention;

FIG. 9B is a top view of the cylindrical multibean antenna, and the beam patterns associated with the cylindrical multibeam antenna, in accordance with an embodiment of the present invention; and

FIG. 10 shows a conical multibeam antenna in accordance with an embodiment of the present invention.

### DETAILED DESCRIPTION OF THE INVENTION

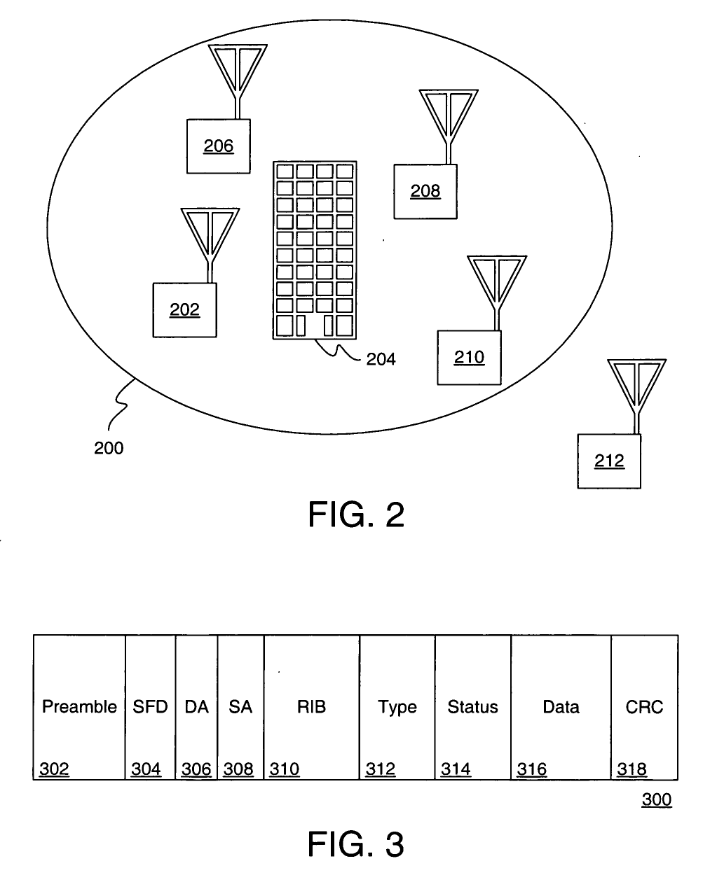

An embodiment of the invention may use Cellular Internet Protocol (CIP) as described in pending U.S. patent application Ser. No. 09/590,780 filed on Jun. 8, 2000. CIP is a protocol for routing packets over a wireless network. FIG. 2 shows an example of such a network. A BTS 202 may be located in a cell 200 of the wireless network. The BTS 202 may provide wireless services to multiple CPEs 206 through 212. There may be obstructions in the cell such as a building 204 that prevent the BTS 202 from having a direct connection to all the CPEs in the cell 200. In addition a CPE, such as CPE 212, might fall outside the boundaries of the cell 200. CIP includes a method for overcoming these obstacles.

The BTS 202 may send a packet to the CPE 210, which is blocked by the building 204 by routing the packet first to the CPE 208, which may then send the packet to the CPE 210. Thus, a communication path with more than one link may be created between the BTS and any CPE. Each CPE along the communication path may be considered a node connecting two of the links in the communication path. The reliability of the wireless network can be increased by creating redundant communication paths between the BTS and any CPE. Thus, CIP may be used to increase the range and reliability of the wireless network.

FIG. 3 is a frame format of an exemplary CIP packet 300 that may be used in an embodiment of the present invention. The packet 300 may be a variable length packet or a fixed length packet for example with a maximum of 512 bytes. The packet may include: a seven byte preamble 302; a one byte start-of-frame delimiter (SFD) 304; a nine byte destination address (DA) 306; a nine byte source address (SA) 308; a 110 byte routing information block (RIB) 310; a six byte type field 312; a six byte status field 314; a 360 byte data field 316; and a 4 byte cyclic redundancy check (CRC) field 318. The arrangement and sizes of the fields described above is exemplary and should not be taken as a limitation of embodiments of the present invention.

The preamble 302 may include alternating ones and zeroes to help in the determination of collisions and to help in synchronization.

The SFD 304 may have a specific value, such as <A5>h or <7E>h, to indicate the beginning of the frame. A hex value of <7E>h is not a valid user data for some encoding schemes such as High level Data Link Control (HDLC).

The DA 306 may have one byte for indicating a region, such as the location within a country of the recipient user station. Two bytes of the DA 306 may be used to indicate the cell identifier within the region. Six bytes of the DA 306 may be used to indicate a CIP address of the recipient within the cell 200.

The SA 308 may have fields similar to the destination address 306 but for identifying the sender instead of the recipient.

The RIB 310 identifies the communication path that the packet 300 takes from the BTS 202 to a destination CPE, or from the destination CPE to the BTS 202. The RIB may identify the nodes in the communication path. The RIB 310 may be limited to 110 bytes, in which case the RIB may only specify 10 nodes in the communication path. Each node may be identified by a network address.

The type field 210 may indicate whether the packet 300 is a control packet or a service packet. In addition, the type field may indicate if the packet 300 is part of a route discovery protocol, an echo protocol or a remote configuration protocol. The type field is used to indicate to the destination CPE if the packet 300 is part of a network management or maintenance packet or is a data packet.

The data field 316 includes the payload of the packet 300.

The CRC field 318 includes information that can be used for error detection and correction.

The BTS 202 may include a BTS routing table with information on all the CPEs that the BTS 202 provides wireless services to. The BTS routing table may include information on the nodes in the communication path between particular CPEs and the BTS 310. The BTS routing table may also include information on alternate communication paths. The BTS routing table may be static or dynamic. A static BTS routing table may be updated manually, while a dynamic BTS routing table may be updated automatically by the BTS.

The BTS routing table may be generated automatically by the BTS 202, or given to the BTS 202 by an external entity (e.g., a network administrator or a networked computer). To generate the BTS routing table, the BTS 202 may start with a list of all the CPEs that the BTS 310 provides wireless services to. The BTS 202 uses the list to generate the BTS routing table by polling (e.g., instructing a particular CPE in a series of CPEs to respond). If the CPE responds then the relevant information about the connection is inserted into the routing table. The BTS 202 repeats this step for each CPE on the list.

If the BTS 202 does not receive a response from a particular CPE then the BTS 202 may send an instruction to one or more other CPEs that did respond in an attempt to establish indirect communication to the particular CPE that did not respond. This instruction may request that the one or more other CPE's forward a request to the particular CPE that did not respond asking the particular CPE to respond. Where the CPE includes multiple antenna's and/or a multibeam antenna, this may include requesting that CPE to attempt communication with the non-responding CPE using each antenna or antenna element. In addition, alternate communication paths between each CPE and the BTS 202 may also be determined. The steps of attempting to communicate with each CPE may be repeated recursively until all the nodes in the communication path (and any possible alternate communication paths) between each CPE and the BTS 202 are determined and entered into the routing table. This process may be repeated until an indirect communication path is established to the non-responding CPE or until all possible paths to that CPE have been exhausted.

In this way, the BTS may establish both direct and indirect communication paths with the CPEs. An indirect communication path may be through any number of intermediate CPEs. The path information is stored in the BTS routing table and inserted into each packet where the information for a packet includes the path information (e.g., node and/or antenna and/or antenna element identifiers) that the packet is to take.

Each individual CPE may include a CPE routing table that includes information on the nodes in the communication path between the individual CPE and the BTS 202. The CPE routing table may contain the same information that is in the BTS routing but only information that is relevant to the individual CPE. For example, the CPE routing table may include information about a particular CPE for which the individual CPE is a node in the communication path between the particular CPE and the BTS 202. The CPE routing table may be used where not all of the routing information needed is included in the packet. For example, the routing table of a CPE may be used during the process described above in which the BTS attempts to establish indirect paths though the CPE.

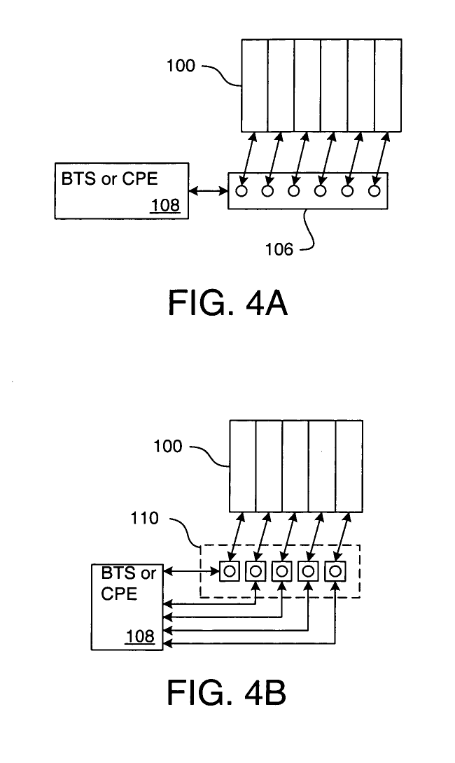

FIG. 4A shows a first system including a multibeam antenna 100, a multiport transceiver 106 and a communication device 108. The communication device 108 may be a Base Transmitter Station (BTS) or a Customer Premises Equipment (CPE). The multiport transceiver 106 may include a switch that allows the communication device 108 to communicate with one antenna element 104 in turn.

FIG. 4B shows a second system including a multibeam antenna 100, a plurality of transceivers 110 and the communication device 108. Each transceiver among the plurality of transceivers 110 may be directly connected to each antenna element 104 included in the multibeam antenna 100. The plurality of transceivers 110 may be connected directly to the communication device 108. The communication device 108 may include a switch that allows the communication device 108 to connect with each transceiver in turn.

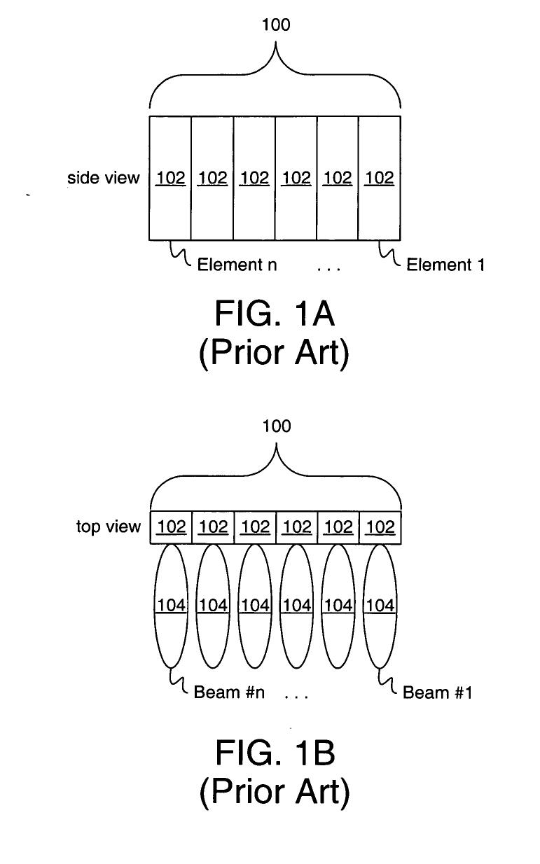

In an embodiment of the present invention, a connection is provided between a communication device (such as the CPE 206-212 and/or the BTS 202 as in FIG. 2) and the multibeam antenna (such as 100 in FIG. 1) and/or a more than one antenna. The connection may include a switch so that the communication device may connect to each element (102) in the antenna (100). In addition, the connection may be made through two or more transceivers that may be connected to each antenna and/or antenna element 104. Alternatively the connection may be made through a multi-port transceiver that includes a switch and is connected in turn to each antenna and/or antenna element 104.

In use, the communication device may cycle through and use each antenna and/or antenna element in turn. Each of the communication devices may be synchronized to a single timing source. The timing source may be based on a GPS signal. Each antenna and/or antenna element may be assigned a time slot, which may be used for transmitting and/or receiving communication signals in which the time slots among the devices are synchronized by the timing source. A synchronization signal may be sent out by the BTS on a regular and/or intermittent basis to ensure that all the communication devices are synchronized to the same timing source.

In a preferred embodiment of the invention, a wireless network is provided in which one or more of the communication devices use two or more antennas and/or a multibeam antenna. If a node on the communication path includes more than one antenna and/or a multibeam antenna, then the packet 300 may include information identifying which antenna and/or antenna element may be used to transmit the packet. This information might be included in the RIB 310, the type field 312, and/or the status field 314. These fields will hereinafter be referred to as routing fields. The routing fields indicate to the communication device which antenna and/or antenna element to use for transmitting and/or receiving the packet 300. For this purpose, each antenna and/or antenna element in the network may be assigned a unique identifier (e.g., a number). Alternatively, the identifier may only be unique to each communication device.

The identification number identifies the communication beam that is associated with the particular antenna and/or antenna element. Each beam has a unique coverage area, orientation, and/or polarization. The CPE and BTS routing tables include the identification number for some or all of the nodes in each communication path listed in the tables.

A particular communication beam may be more suitable for communicating with a particular communication device than another communication beam. In an embodiment of the present invention, the CPE and BTS routing tables are generated and a particular identification number is assigned to a particular node in a particular communication path. The identification number may be assigned to maximize the communication device's performance. A first step may be to use one of the communication beams to attempt communication with a particular CPE. More than one attempt may be made to create a communication link with the particular CPE. Once the communication link is successfully created then a traffic load is generated to calculate traffic performance of the communication link. The BTS may use this method to calculate the traffic performance of all the communication beams and the particular CPE. The communication link with the best performance is assigned to the particular CPE.

One method of calculating the traffic performance is to send a “Start Link Test” message to the particular CPE using a particular communication beam. The particular CPE upon receiving this message may reset a link test counter that is included in the particular CPE. A predefined number of messages may then be sent to the particular CPE. The particular CPE may increment the link test counter upon the successful reception of each message. Once the predefined number of messages has been sent, a request may be made that the particular CPE respond with the current value of the link test counter. This value, which is a measure of traffic performance, may be stored in a link test table along with an identification number that is associated with the particular communication beam. If no link could be created with the particular CPE using a particular communication beam then a traffic performance value of zero may be stored along with the identification number in the link test table.

After the link test table has included a measure of traffic performance for each identification number, the identification number that is associated with the greatest measure of traffic performance is associated with the particular CPE in the BTS routing table. If a plurality of identification numbers has the same greatest measure of traffic performance then the identification number that is in the center of the sector associated with this plurality of identification numbers is associated with the particular CPE in the BTS routing table and/or the plurality of identification numbers is associated with the particular CPE in the BTS routing table as alternate routes.

If the CPE does not have a current CPE routing table and is not able to communicate directly or through an intermediary with the BTS, then the CPE may enter a search mode. If the CPE is in a search mode and is connected to more than one antenna and/or a multibeam antenna then the search mode may includes switching regularly or randomly between antennas and/or antenna elements and listening for packets 300 that include the network address of the CPE. The network address may be in the DA field 306 or as part of the RIB 310.

The communication device may not be able to listen to all of antennas and/or antenna elements to which it is connected to at once. Thus, each antenna and/or antenna element may be assigned a time slot in which it is used. The BTS and CPE routing tables should include this timing information along with the identification number. This timing information may be programmed into the BTS and/or CPE or may be included in the packet 300.

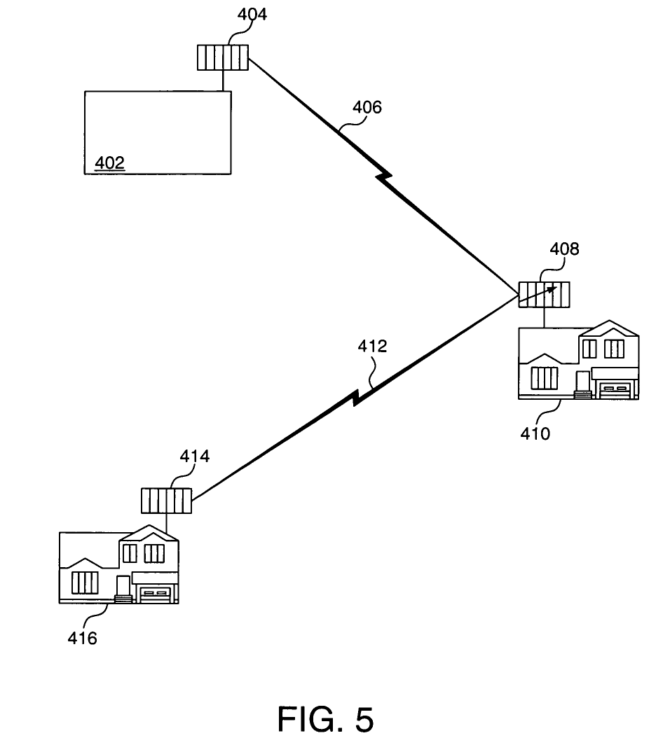

FIG. 5 shows a system in which an embodiment of the invention may be implemented. A BTS 402 may use a multibeam antenna 404 to communicate with a CPE 416 via a CPE 410. The BTS 402 uses a selected element of the multibeam antenna 404 to send a packet 300 (FIG. 3) over a communication beam 406 to be received by an element of a multibeam antenna 408 that is connected to the CPE 410.

The CPE 410 checks the routing fields in the packet 300. The routing fields include information on whether to forward the packet 300 on to a second location. The second location may or may not be the final destination for the packet 300. Thus, the routing fields include information on whether to forward the packet 300 on to a sequence of locations in order or to multicast to a plurality of destinations using a global address. The routing fields include the identification numbers associated with the communication beams 406 and 412 and the network addresses of the CPEs 410 and 416.

The CPE 410 may then send the packet 300 over a communication beam 412 using an element of the multibeam antenna 408, identified in the packet 300. The packet 300 is received by an element of a multibeam antenna 414 that is connected to the CPE 416, also identified in the packet 300.

The BTS 402 may be aware that the CPE 410 will only be listening to the element that best receives the communication beam 406. Therefore, the BTS 402 transmits the packet 300 on the beam 406. Similarly, the CPE 410 may be aware that the CPE 416 will only be listening to the element that best receives the communication beam 412. The CPE 410 transmits the packet 300. Alternatively, the antennas 408 and/or 414 may be omni-directional or directional antennas as opposed to multibeam antennas. Thus, the BTS 402 can arrange for the packet 300 to be delivered to the CPE 416.

This use of multibeam antennas allows the system as shown in FIG. 5 to establish a directed beam in space (in contrast to the prior art which does not use multibeam antennas), thereby making the system more resilient. Those skilled in the art will also appreciate that the present system and method will be less susceptible to interference over the network, relative to prior systems.

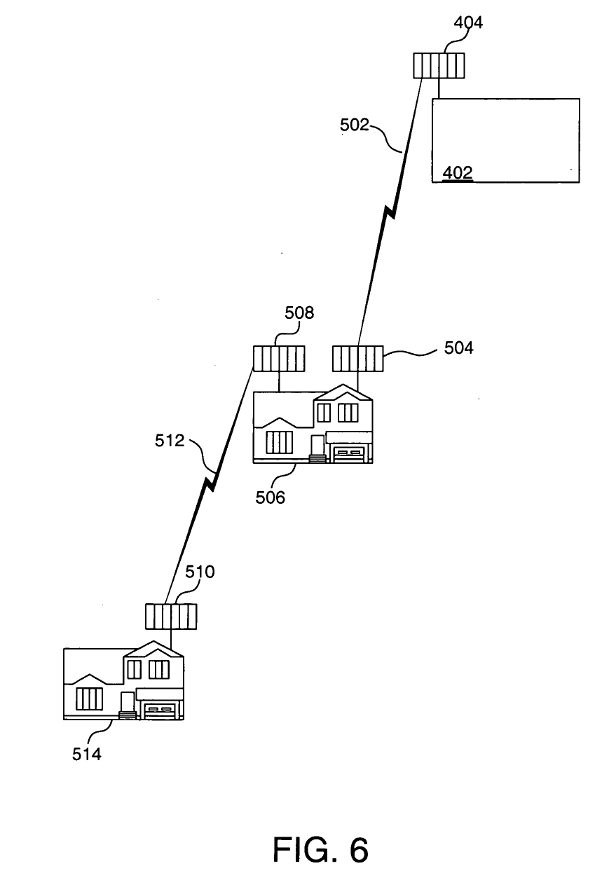

FIG. 6 shows a system in which an embodiment of the invention may be implemented. A BTS 402 may use a multibeam antenna 404 to communicate with a CPE 514 via a CPE 506. FIG. 6 differs from FIG. 5 in that the CPE 506 includes a plurality of antennas as opposed to CPE 410, which includes one antenna. A first antenna may be used to communicate with the BTS 402 while a second antenna is used to communicate with the CPE 514. The BTS 402 uses an element of the multibeam antenna 404 to send a packet 300 over a communication beam 502 to be received by an element of a multibeam antenna 504 that is connected to the CPE 506. The antenna 504 may be a directional antenna or a omni-directional antenna.

The CPE 506 checks the routing fields in the packet. The routing fields include information on whether to forward the packet on to a second location. The second location may not be the final destination for the packet. Thus, the routing fields include information on whether to forward the packet 300 on to a sequence of locations. The routing fields include the identification numbers associated with the communication beams 502 and 512, the appropriate antennas associated with the communication beams, and the network addresses of the CPEs 506 and 514. The routing field may include a number that identifies an antenna element and/or an antenna among a plurality of antennas. The routing field may indicate that the packet should be rebroadcast as a multicast packet to a plurality of network addresses or to all network addresses by indicating a general network address.

The CPE 506 may then send a packet 300 over a communication beam 512 using an element of a multibeam antenna 508. The antenna 504 may be a directional antenna or an omni-directional antenna. The packet 300 is received by an element of a multibeam antenna 510 that is connected to the CPE 514. The packet 300 includes information instructing the CPE 506 to forward the packet 300 on to the CPE 514 using the communication beam 512. This information may be located in the routing fields of the packet 300.

As shown in FIG. 6 the CPE 506 may have more than one antenna. For example, each antenna might have different properties such as directionality, polarization, and/or range. As still another example, one antenna may have a wider beam than the other to provide more coverage. Further, one of the antennas may be directional while another antenna is omni-directional. The different features of each antenna may be used to improve the communication devices reliability.

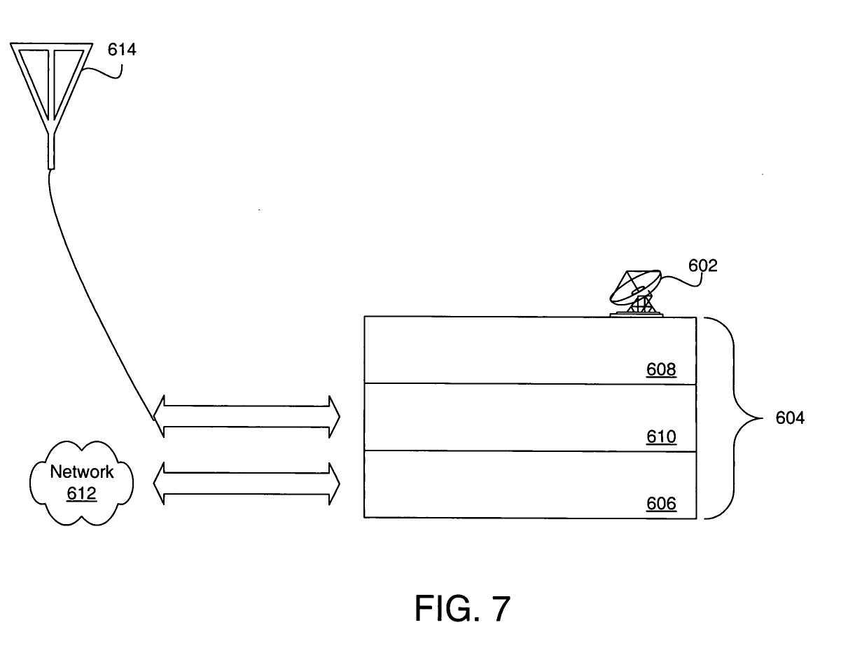

FIG. 7 is a block diagram of an exemplary BTS, which may be used in an implementation of an embodiment of the present invention. A BTS 604 may include: a Global Positioning Satellite (GPS) antenna 602; a GPS unit 608; an RF unit 610 and a BTS control unit 606. The BTS 604 may use a GPS signal detected by the GPS antenna 602 and processed by the GPS unit 608 to allow all the base stations to a have a common timing reference. The RF unit 610 is connected to an antenna 614. The RF unit 610 may be used to drive the antenna 614 directly or may do so through an intermediary transceiver and/or amplifier. The antenna 614 may be a multibeam antenna. In which case, the RF unit 610 includes or is connected to a multiport transceiver through which the multibeam antenna 614 is driven. Alternatively, the RF unit 610 may include or be connected to a switch through which the RF unit 610 may connect with each element of the multibeam antenna 614 directly or through transceivers that are connected to each element. The BTS control unit 606 may include a controller that provides instructions for the RF unit 610. The BTS control unit 606 is connected to a wired network 612. Thus, the BTS 604 provides a bridge for allowing a wireless network to communicate with the wired network 612.

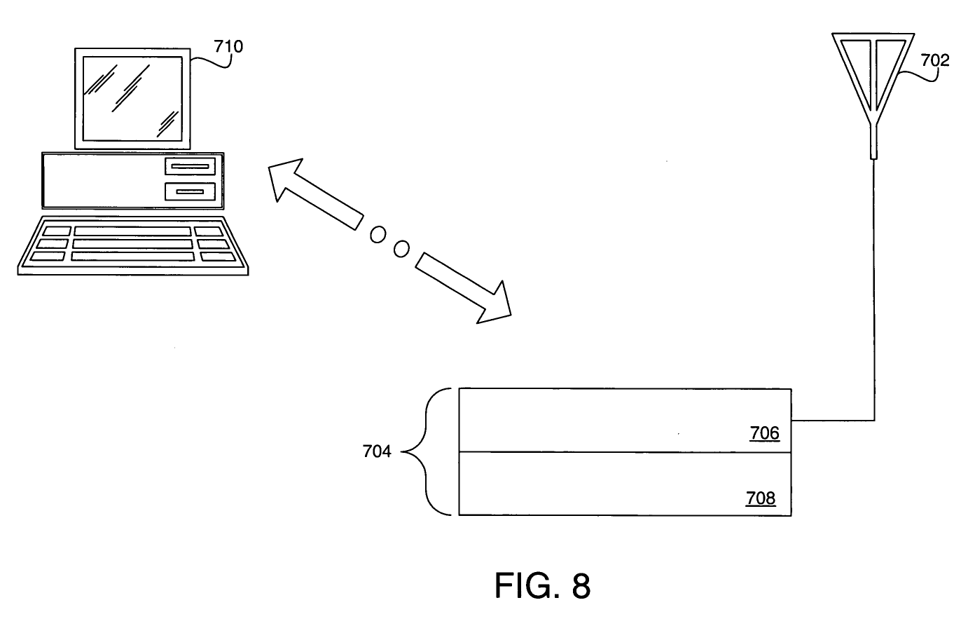

FIG. 8 is a block diagram of an exemplary CPE, which may be used in an implementation of an embodiment of the present invention. The CPE 704 may include an RF unit 706 and a CPE control unit 708. The RF unit 706 may be connected to an antenna 702. The RF unit 706 may be used to drive the antenna 702 directly or may do so through an intermediary transceiver and/or amplifier. The antenna 702 may be a multibeam antenna. The RF unit 706 may include or be connected to the multiport transceiver (106 in FIG. 1C) through which the multibeam antenna 702 is driven. Alternatively, the RF unit 706 may include or be connected to a switch through which the RF unit 706 may connect with each element of the multibeam antenna 702 directly or through the plurality of transceivers (110 in FIG. 1D) that are connected to each element. The CPE control unit 708 may include a controller that provides instructions for the RF unit 708. The CPE control unit 606 may include a connection to a computer 710. The CPE 704 may provide a bridge for allowing the wireless network to communicate with the computer 712. The CPE control unit 708 may send a control packet to a switch instructing it to switch to a particular antenna and/or antenna element. The switch may respond by informing the CPE control unit once the switch has occurred or with an error message if the switch has failed to occur.

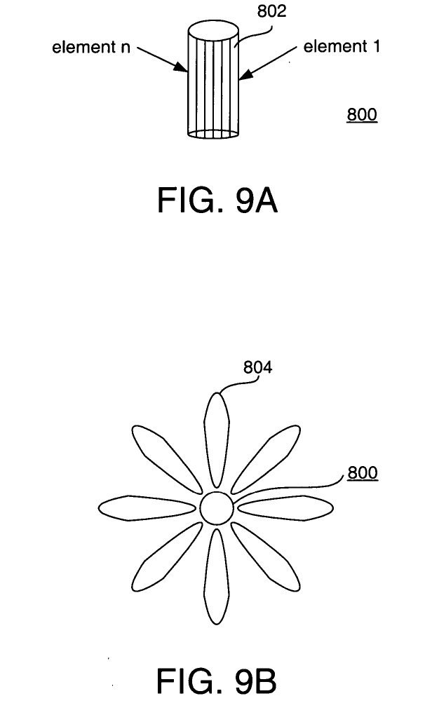

FIG. 9A is a side view of a cylindrical multibeam antenna 800, in accordance with an embodiment of the present invention. The cylindrical multibeam antenna 800 is a substantially cylindrical apparatus that includes two or more antenna elements 802 which are preferably arranged in a manner such that the antenna 800 provides a substantially omni-directional communication beam pattern, such that the coverage area extends over 360 degree area. In particular, antenna 800 may be an n-sided polygon with n elements 802 which is arranged in a manner such that the antenna 800 provides a substantially omni-directional or semi-directional communication beam pattern. In other words each element 802 is oriented in a different direction as opposed to the prior art wherein each element is oriented in the same direction as in the planar multibeam antenna shown in FIGS. 1A-B.

FIG. 9B is a top view of the cylindrical multibeam antenna 800, in accordance with an embodiment of the present invention and a plurality of communication beams 804 associated with the antenna 800. Each communication beam 804 is associated with an antenna element 802. Each element 802 is oriented in a different direction, such that the coverage area provided by the cylindrical multibeam antenna extends along an arc or circle as opposed to expanding along a straight line as in the prior art shown in FIG. 1B. The divergence of each communication beam 804 may be greater than the divergence associated with a planar multibeam antenna to provide less dead area between the communication beams 804.

The antenna 800 may be in the shape of a cylinder, a polygon, an arc, or a portion of a polygon. The coverage area may be spherical, cylindrical or semi-directional covering a portion of a sphere or cylinder. The communication beams 804 may be horizontally polarized, vertically polarized and/or dual-polarized.

The antenna 800 may be used in a packet oriented wireless network that is in accordance with an embodiment of the present invention, wherein the packet 300 has routing fields that identify which element 802 of the multibeam antenna 800 to use for the packet 300 as discussed herein.

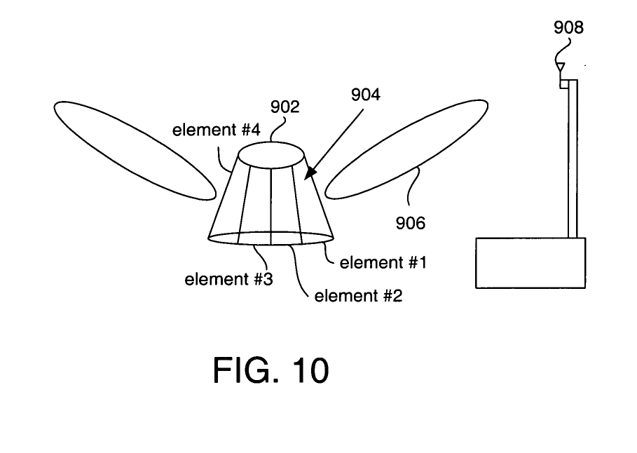

FIG. 10 shows a system that includes a conical multibeam antenna 902 in accordance with an embodiment of the present invention. The antenna 902 has a substantially conical construction. Thus, the antenna 902 includes two or more elements 904, which may have an upward or downward tilt or angle relative to the vertical. The tilt may fixed or mechanically adjustable. Each element 904 may have a unique tilt or some or all of the elements may have the same tilt. An advantage of the conical multibeam antenna is that each element may be oriented to provide an efficient communication link with a second antenna 908 that is at a different elevation than the conical multibeam antenna. The antenna 902 produces a communication beam 906 that is tilted so that the communication beam is substantially aligned with the second antenna 908. A standard directional antenna, as in the prior art, has a horizontal beam pattern and provides a poor link with a second antenna that is at a different elevation. An advantage of the conical multibeam antenna 902 is the allowance of high gain, narrow beam antenna elements 904 that may be tilted so as to communicate with the second antenna 908 that has a different elevation then the antenna 902. An antenna for a BTS is often at higher elevation then the antennas for CPEs therefore a directional antenna with an upward tilt would provide a significant advantage. The elements 904 may be arranged such that an omni-directional, a partial omni-directional, or a quarter omni-directional pattern may be realized.

For example an antenna for a BTS may be attached to a high building, while a CPE may be located at a lower elevation at a customers residence. Thus, a conical multibeam antenna may be tilted up to provide a strong link between the BTS and the CPE. Alternatively, the CPE may be on a hill, while the BTS is in a valley, in this case the conical multibeam antenna may be tilted downward to provide a strong link.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing form the spirit and scope of the invention.

What is claimed is:

1. An antenna apparatus comprising a plurality of directional antenna elements, wherein each element of the plurality of elements is oriented in a different direction relative to an axis, and each element is identified by an identifier.

2. The apparatus of claim 1, wherein the plurality of elements are arranged so as to form a substantially cylindrical apparatus.

3. The apparatus of claim 1, wherein the plurality of element are arranged so as to form an arc.

4. The apparatus of claim 1, wherein at least one of the elements is tilted at an angle relative to a horizontal plane.

5. The apparatus of claim 4, wherein the plurality of elements are arranged so as to form a substantially conical apparatus.

6. The apparatus of claim 1, wherein a packet communicated by the antenna includes a dedicated routing field which includes an identifier that identifies a specified element among the plurality of elements, wherein the specified element is used for communicating of the packet.

7. The apparatus of claim 6, wherein the routing field of the packet further includes routing information, identifying at least one intermediary communication device between a source of the packet and a final destination of the packet.

8. The apparatus of claim 6, wherein the identifier that identifies the element that transmits the packet.

9. A system comprising a first node and a second node in a wireless network, wherein a packet is used for communicating between the first and second node, and the packet includes a dedicated routing field that includes an identifier that identifies a specified antenna among a plurality of antennas which are included in a node among the group consisting of the first node and the second node, and the specified antenna is used in the communication of the packet.

10. The system of claim 9, wherein the first node comprises a base station, the second node comprises a customer premises equipment, and the system further comprises a plurality of nodes which comprises customer premises equipment, and the dedicated routing field in the packet further identifies at least one customer premises equipment as a node(s) in a path that the packet takes between the base station and a specific customer premises equipment device, wherein the specific customer premises equipment device is selected from the group consisting of the source of the packet and the destination of the packet.

11. The system of claim 10, wherein a node in the path includes a plurality of antennas and a first antenna of the plurality of antennas is used to communicate with the base station, and a second antenna of the plurality of antennas is used to communicate with another node in the path, and wherein each antenna and the nodes in the path are identified in the packet.

12. The system of claim 10, wherein the dedicated routing field includes further instructions to multicast the packet to a subset of the plurality of nodes.

13. The system of claim 9, wherein the identifier identifies the antenna that transmits the packet.

14. The system of claim 9, wherein the specified antenna is a specified antenna element and the plurality of antennas is a multibeam antenna that includes a plurality of antenna elements.

15. The system of claim 14 wherein, wherein each element of the multibeam antenna is oriented in a different direction relative to an axis.

16. The system of claim 14, wherein the element is tilted at an angle relative to a horizontal plane.

17. A method of communicating over a wireless network with a packet comprising the steps of: inspecting a packet to determine an identifier that is included in a routing field in the packet; and transmitting the packet using an antenna among a plurality of antennas that is identified by the identifier.

18. The method of claim 17, wherein the antenna is a directional antenna element and the plurality of antenna elements is a multibeam antenna.

19. The method of claim 17, wherein the routing field of the packet further includes routing information, identifying at least one intermediary communication device between a source of the packet and a final destination of the packet.

20. The method of claim 17, wherein the identifier identifies the antenna that receives the packet.

21. The method of claim 17, wherein the identifier identifies the antenna that transmits the packet.

22. The method of claim 17, wherein the plurality of antennas includes antennas having different polarizations.

23. A method of communicating choosing a particular antenna among a plurality of antennas to communicate a with a particular node in a wireless network that comprises the steps of:
attempting at least once to create a communication link with the particular node using one antenna among a plurality of antennas;
measuring traffic performance of the communication link when a link is formed;
repeating said steps of attempting and measuring for each antenna among the plurality of antennas; and
choosing an antenna from among the plurality based on traffic performance for the particular node.

24. The method of claim 23, wherein the antenna is an antenna element and the plurality of antennas is a multibeam antenna.

25. The method of claim 23, wherein the plurality of antenna is at a destination of the packet.

26. The method of claim 23, wherein the plurality of antenna is at a source of the packet.

27. The method of claim 23, wherein the step of measuring the traffic performance comprises the steps of:
sending a series of data packets to the node;
counting how many packet are successfully received by the node; and
reporting the number of successfully received packets as a measure of the traffic performance.

28. The method of claim 23, further comprising adding the antenna chosen from among the plurality of antennas to a routing table.

29. The method of claim 23, further comprising instructing a one or more other node in the wireless network to attempt to communicate with the particular node, thereby establishing an indirect communication path to the particular node.

30. A method of a customer premises equipment finding a node to communicate with, comprising the steps of: listening for packets that include the network address of the customer premises equipment in the packet; and responding to said packet.

31. The method of claim 30, wherein the network address is included in a routing information block that is included in the packet.

32. The method of claim 30, wherein the network address is included in a destination address field that is included in the packet.

33. The method of claim 30, wherein the customer premises equipment includes a plurality of antennas, and the customer premises equipment switches between the plurality of antennas to listen for said packet.

34. The method of claim 33, wherein the switching between the plurality of antennas occurs at regular intervals.

35. The method of claim 33, wherein the switching between the plurality of antennas occurs at intermittent intervals.

36. The method of claim 33, wherein the plurality of antennas is a multibeam antenna and each antenna is an antenna element of the multibeam antenna.

37. A system comprising a first node and a second node in a wireless network, wherein a packet is used for communicating between the first and second node, and the packet includes a dedicated routing field that includes an identifier that identifies a specified element of a multibeam antenna which is included in a node among the group consisting of the first node and the second node, and the specified element is used in the communication of the packet.

38. The system of claim 37, wherein the first node comprises a base station, the second node comprises a customer premises equipment, and the system further comprises a plurality of nodes which comprises customer premises equipment, and the dedicated routing field in the packet further identifies at least one customer premises equipment as a node(s) in a path that the packet takes between the base station and a specific customer premises equipment device, wherein the specific customer premises equipment device is selected from the group consisting of the source of the packet and the destination of the packet.

39. The system of claim 40, wherein one node in the path includes a multibeam antenna that includes a plurality of elements and a first element of the multibeam antenna is used to communicate with the base station, and a second element of the multibeam antenna is used to communicate with another node in the path, and wherein each element and the nodes in the path are identified in the packet.

40. The system of claim 38, wherein the dedicated routing field includes further instructions to multicast the packet to a subset of the plurality of nodes.

41. The system of claim 38, wherein the identifier identifies the element that transmits the packet.

42. The system of claim 37 wherein, wherein each element of the multibeam antenna is oriented in a different direction relative to an axis.

43. The system of claim 37, wherein the element is tilted at an angle relative to a horizontal plane.

44. A method of communicating over a wireless network with a packet comprising the steps of: inspecting a packet to determine an identifier that is included in a routing field in the packet; and transmitting the packet using an element among a plurality of element in a multibeam antenna that is identified by the identifier.

45. The method of claim 44, wherein the routing field of the packet further includes routing information, identifying at least one intermediary communication device between a source of the packet and a final destination of the packet.

46. The method of claim 44, wherein the identifier identifies the element that transmits the packet.

47. A method of communicating choosing a particular element among a plurality of elements in a multibeam antenna to communicate with a particular node in a wireless network that comprises the steps of:
attempting at least once to create a communication link with the particular node using one element among a plurality of elements in a multibeam antenna;
measuring traffic performance of the communication link when a link is formed;
repeating said steps of attempting and measuring for each element among the plurality of elements; and
choosing an element from among the plurality based on traffic performance for the particular node.

48. The method of claim 47, wherein the multibeam antenna is at a destination of the packet.

49. The method of claim 47, wherein the multibeam antenna is at a source of the packet.

50. The method of claim 47, wherein the step of measuring the traffic performance comprises the steps of:
sending a series of data packets to the node;
counting how many packet are successfully received by the node; and
reporting the number of successfully received packets as a measure of the traffic performance.

51. The method of claim 47, further comprises adding the element chosen from among the plurality of elements to a routing table.

52. The method of claim 47, further comprising instructing a one or more other node in the wireless network to attempt to communicate with the particular node, thereby establishing an indirect communication path to the particular node.

53. A system comprising a first node and a second node in a wireless network; wherein a packet is used for communicating between the first and second node, and the packet includes a dedicated routing field that includes an antenna identifier and an element identifier, wherein the antenna identifier identifies a specified antenna among a plurality of antennas which are included in a node among the group consisting of the first node and the second node, and the specified antenna is a multibeam antenna including a plurality elements and the element identifier identifies a specific element among the plurality of elements and the specified element of the specified antenna is used in the communication of the packet.

54. The system of claim 53, wherein the first node comprises a base station, the second node comprises a customer premises equipment, and the system further comprises a plurality of nodes which comprises customer premises equipment, and the dedicated routing field in the packet further identifies at least one customer premises equipment as a node(s) in a path that the packet takes between the base station and a specific customer premises equipment device, wherein the specific customer premises equipment device is selected from the group consisting of the source of the packet and the destination of the packet.

55. The system of claim 54, wherein a node in the path includes a plurality of antennas and a first antenna of the plurality of antennas is used to communicate with the base station, and a second antenna of the plurality of antennas is used to communicate with another node in the path, and wherein each antenna and the nodes in the path are identified in the packet.

56. The system of claim 54, wherein a node in the path includes a multibeam antenna which includes a plurality of elements and a first element of the plurality of elements is used to communicate with the base station, and a second element of the plurality of element is used to communicate with another node in the path, and wherein each element and the nodes in the path are identified in the packet.

57. The system of claim 54, wherein the dedicated routing field includes further instructions to multicast the packet to a subset of the plurality of nodes.

58. The system of claim 53, wherein the antenna identifier identifies the antenna that transmits the packet.

59. The system of claim 53, wherein the element identifier identifies the element that transmits the packet.

60. The system of claim 53 wherein, wherein each element of the multibeam antenna is oriented in a different direction relative to an axis.

61. The system of claim 53, wherein the element is tilted at an angle relative to a horizontal plane.

62. A method of communicating over a wireless network with a packet comprising the steps of: inspecting a packet to determine an antenna identifier and a element identifier that is included in a routing field in the packet; and transmitting the packet using a specific element of a specific antenna among a plurality of antennas wherein the specific antenna is identified by the antenna identifier and the specific element is identified by the element identifier.

63. The method of claim 62, wherein the routing field of the packet further includes routing information, identifying at least one intermediary communication device between a source of the packet and a final destination of the packet.

64. The method of claim 62, wherein the antenna identier identifies the antenna that transmits the packet.

65. The method of claim 62, wherein the element identifier identifies the element that transmits the packet.

66. A method of communicating choosing a particular antenna among a plurality of antennas wherein each antenna includes a plurality of elements to communicate with a particular node in a wireless network that comprises the steps of:
attempting at least once to create a communication link with the particular node using one element among the plurality of elements included in an antenna among the plurality of antennas;
measuring traffic performance of the communication link when a link is formed;
repeating said steps of attempting and measuring for each element among the plurality of elements and the plurality of antennas; and
choosing an element from among the plurality of elements and antennas based on traffic performance for the particular node.

67. The method of claim 66, wherein the plurality of antenna is at a destination of the packet.

68. The method of claim 66, wherein the plurality of antenna is at a source of the packet.

69. The method of claim 66, wherein the step of measuring the traffic performance comprises the steps of:
sending a series of data packets to the node;
counting how many packet are successfully received by the node; and
reporting the number of successfully received packets as a measure of the traffic performance.

70. The method of claim 66, further comprising adding the antenna and the element chosen from among the plurality of antennas and elements to a routing table.

71. The method of claim 66, further comprising instructing a second node in the wireless network to attempt to communicate with the particular node, wherein the second node includes the plurality of antennas.
